(19) United States
(12) Patent Application Publication
(10) Pub. No.: US 2026/0296159 A1
(43) Pub. Date: Oct. 1, 2026

(54) BATTERY MOUNTING STRUCTURE FOR VEHICLE

(71) Applicant: TOYOTA JIDOSHA KABUSHIKI KAISHA, Toyota-shi (JP)

(72) Inventors: Shota YONEZAWA, Toyota-shi (JP); Kotaro Horiguchi, Nagoya-shi (JP)

(73) Assignee: TOYOTA JIDOSHA KABUSHIKI KAISHA, Toyota-shi (JP)

(21) Appl. No.: 19/451,023

(22) Filed: Jan. 16, 2026

(30) Foreign Application Priority Data
Mar. 26, 2025 (JP) 2025-052320

(51) Int. Cl. B60K 1/04

(52) U.S. Cl. CPC B60K 1/04; B60K 2001/0438

(57) ABSTRACT

The battery mounting structure for a vehicle includes: an upper cover disposed above an energy storage cell; a device disposed above the energy storage cell and the upper cover and electrically connected to the energy storage cell; a device base on which the device is mounted, the device base being made of metal and disposed above the upper cover with a gap between the device base and the upper cover; and a projection provided on a lower surface of the device base and protruding downward.

### CROSS-REFERENCE TO RELATED APPLICATION

This application claims priority to Japanese Patent Application No. 2025-052320 filed on Mar. 26, 2025. The disclosure of the above-identified application, including the specification, drawings, and claims, is incorporated by reference herein in its entirety.

### BACKGROUND

### 1. Technical Field

The present disclosure relates to structures for mounting a battery on a vehicle.

### 2. Description of Related Art

Japanese Unexamined Patent Application Publication No. 2023-46977 (JP 2023-46977 A) discloses a battery pack structure in which an energy storage module is housed in a case, with a thermally insulating material disposed above the energy storage module.

### SUMMARY

In vehicle interior layouts, devices that are electrically connected to energy storage cells constituting a battery module are sometimes arranged above the energy storage cells. In such a case, for example, when the devices generate heat, the heat may be transferred from the devices to the energy storage cells, possibly causing uneven temperature distribution in the energy storage cells. Accordingly, it may be effective to place a thermally insulating material as described in JP 2023-46977 A. On the other hand, a structure capable of dissipating heat generated by the devices is also desirable for suppressing overheating of the devices.

In view of the above, the present disclosure provides a battery mounting structure for a vehicle that can dissipate heat generated by a device.

A battery mounting structure for a vehicle of a first aspect includes: an upper cover disposed above an energy storage cell; a device disposed above the energy storage cell and the upper cover and electrically connected to the energy storage cell; a device base on which the device is mounted, the device base being made of metal and disposed above the upper cover with a gap between the device base and the upper cover; and a projection provided on a lower surface of the device base and protruding downward.

In the battery mounting structure of the first aspect, since the device base is made of metal, it has higher thermal conductivity than a device base made of, for example, resin. Accordingly, heat generated by the device mounted on the device base can be more readily absorbed by the device base.

Since the projection increases the surface area of the lower surface of the device base, heat is more readily dissipated from the device base to the gap between the device base and the upper cover. Accordingly, compared with a configuration without the projection, heat generated by the device mounted on the device base can be more readily dissipated.

On the other hand, since air has lower thermal conductivity than resin or metal, heat dissipated from the device base is less likely to be transferred to the upper cover through the gap between the device base and the upper cover. Accordingly, heat transfer to the energy storage cell can be suppressed.

According to a battery mounting structure for a vehicle of a second aspect, in the battery mounting structure of the first aspect, the device base is box-shaped and has an opening at an upper end of the device base, and the battery mounting structure further includes a lid that closes the opening at the upper end of the device base.

In the battery mounting structure of the second aspect, since the device is housed in a box-shaped space formed by the device base and the lid, the device is better protected compared with a configuration without the lid.

On the other hand, since the device is housed in the box-shaped space formed by the device base and the lid, heat generated by the device tends to accumulate within the space. However, this heat can be absorbed by the device base and dissipated through the projection.

According to a battery mounting structure for a vehicle of a third aspect, in the battery mounting structure of the first or second aspect, the projection is provided in a grid pattern along a vehicle width direction and a vehicle front-rear direction.

In the battery mounting structure of the third aspect, the surface area of the lower surface of the device base can be more easily increased compared with a case where the projection is provided as a rib extending along the vehicle width direction or a rib extending along the vehicle front-rear direction.

According to a battery mounting structure for a vehicle of a fourth aspect, in the battery mounting structure of any one of the first to third aspects, the device is partially disposed above the energy storage cell and the upper cover.

In a case where the device is partially disposed above the energy storage cell as in the battery mounting structure of the fourth aspect, the energy storage cell may be partially heated.

However, in this battery mounting structure, a gap is provided between the device base and the upper cover for the energy storage cell. Therefore, the gap functions as a thermally insulating layer, which suppresses heat transfer from the device base to the energy storage cell through the upper cover, thereby reducing partial heating of the energy storage cell.

The present disclosure makes it possible to dissipate heat generated by a device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view showing a main portion of a battery mounting structure for a vehicle according to an embodiment of the present disclosure;

FIG. 2 is a side sectional view showing an example of the battery mounting structure according to the embodiment of the present disclosure;

FIG. 3 is a partially enlarged side sectional view showing an example of projections of a device base, recesses of an upper cover, and a resin member according to the embodiment of the present disclosure;

FIG. 4A is a bottom view showing an example of the projections of the device base according to the embodiment of the present disclosure;

FIG. 4B is a bottom view showing a first modification of the projections of the device base according to the embodiment of the present disclosure; and

FIG. 4C is a bottom view showing a second modification of the projections of the device base according to the embodiment of the present disclosure.

### DETAILED DESCRIPTION OF EMBODIMENTS

Hereinafter, a battery mounting structure for a vehicle according to an embodiment of the present disclosure will be described with reference to the drawings. Components denoted by the same signs in the drawings represent the same components. Unless otherwise specified, each component is not limited to a single one, and two or more may be provided.

Description of identical structures and signs in the drawings may be omitted as appropriate. The present disclosure is not limited to the embodiment described below. Various changes and modifications may be made as appropriate within the spirit and scope of the disclosure. For example, some components may be omitted or replaced with others, or one embodiment may be combined with various modifications as appropriate.

### Vehicle Structure

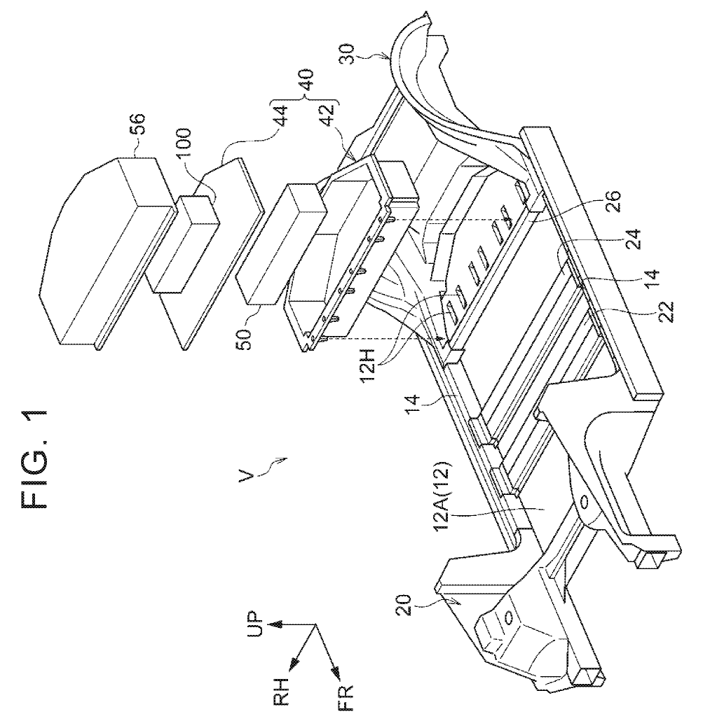

FIG. 1 is a perspective view showing a main portion of a vehicle V to which the battery mounting structure according to the embodiment of the present disclosure is applied. In the drawings, arrows FR, UP, and RH indicate the front, upward, and rightward directions of the vehicle V, respectively.

As shown in FIG. 1, a battery case 12 is provided near the center of the vehicle V in the vehicle front-rear direction. The battery case 12 is installed in the lower part of the vehicle. The upper surface of the battery case 12 forms the floor of the vehicle cabin. Therefore, the vehicle V of the present embodiment does not include a separate floor panel.

On both sides of the battery case 12 in the vehicle width direction, a pair of right and left rockers 14 extends along the vehicle front-rear direction. Each rocker 14 is a structural member having a generally rectangular closed cross-section. The battery case 12 is mounted to the rockers 14 using fasteners (not shown).

The front ends of the rockers 14 are connected to a front module 20. The rear ends of the rockers 14 are connected to a rear module 30. The front module 20 and the rear module 30 are each formed integrally by, for example, casting.

A first cross member 22 and a second cross member 24, both serving as cross members, are provided at the central portions of the rockers 14 in the vehicle front-rear direction. The first cross member 22 and the second cross member 24 extend in the vehicle width direction above the battery case 12 and are disposed between the rockers 14. Front vehicle seats (not shown) are mounted to the first and second cross members 22, 24.

A third cross member 26, serving as a cross member, is provided at the rear portions of the rockers 14 in the vehicle front-rear direction. The third cross member 26 also extends in the vehicle width direction above the battery case 12 and is disposed between the rockers 14. The detailed configuration of the third cross member 26 will be described later.

### Battery Case

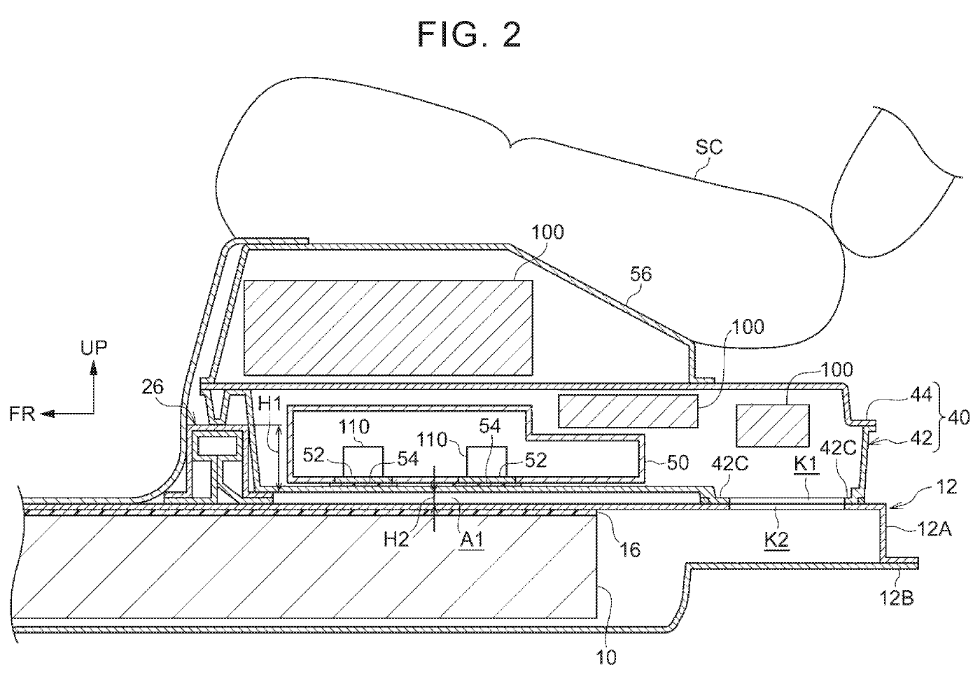

As shown in FIG. 2, the battery case 12 is generally in the shape of a box and includes an upper case 12A and a lower case 12B. A battery 10 (energy storage cell) is housed inside the battery case 12.

The upper case 12A is an upper cover that is disposed above the battery 10 and covers the battery 10. As described above, the upper surface of the upper case 12A forms the floor of the vehicle cabin. The upper case 12A has an opening K2 at its rear end in the vehicle front-rear direction. The interior space of the battery case 12 communicates with the interior space of a device case 40 described later through the opening K2.

The battery case 12 may be constituted by the upper cover that covers the upper side of the battery 10. In this case, a member that supports the battery 10 from below may be provided instead of the lower case 12B.

### Device Case

A device case 40 is disposed above the battery case 12. The device case 40 includes a device base 42 and a lid 44. The device base 42 is a box-shaped housing with an open top.

The material of the device base 42 is not particularly limited. However, to improve the heat dissipation performance of heat-generating devices such as a relay 110 described later, a material with high thermal conductivity such as aluminum is preferred. The device base 42 is more preferably a die-cast member (casting) made of, for example, aluminum.

The lid 44 is a sealing member that closes the opening at the upper end of the device base 42. The lid 44 is fixed to the device base 42 using fasteners (not shown).

In the present disclosure, the device base 42 may not be a casting. The device base 42 may instead be formed from a metal sheet (for example, aluminum or stainless steel) or from resin. Even when the device base 42 is formed from a metal sheet or resin, heat generated by the heat-generating devices such as the relay 110 is dissipated to the device base 42.

### Junction Box

A junction box 50 housing the heat-generating devices such as the relay 110 is disposed inside the device case 40. The junction box 50 is placed on the device base 42 and fixed to the device base 42 using fasteners (not shown).

In addition to the junction box 50, auxiliary devices 100 are also provided inside the device case 40. The auxiliary devices 100 include, for example, a power distribution unit (PDU) and an electronic control unit (ECU).

The relay 110 and the auxiliary devices 100 are connected to the battery 10 via a busbar or wire harness (not shown) and are electrically connected to the battery 10. The heat-generating devices such as the relay 110 are driven by electric power supplied from the battery 10 and may generate heat during operation.

The relay 110 and the junction box 50 are partially disposed above the battery 10 and the upper case 12A. The phrase "partially disposed" indicates, for example, that with respect to the battery 10 extending in the vehicle front-rear direction and the vehicle width direction, these components are positioned above a portion of the battery 10 (for example, its rear portion) in the vehicle front-rear direction.

The junction box 50 has an opening at its bottom, and a heat-dissipating sheet 52 is disposed in the opening. The relay 110 is disposed above the heat-dissipating sheet 52. In other words, the heat-dissipating sheet 52, a thermally conductive member, is interposed between the relay 110 and the device base 42. Heat generated when the relay 110 operates is transferred to the device base 42 through the heat-dissipating sheet 52. An insulating sheet 54 is disposed below the heat-dissipating sheet 52.

In the present disclosure, the heat-dissipating sheet 52 may not be provided. The heat-dissipating sheet 52 may be omitted as appropriate. In this case, an opening may not be formed at the bottom of the junction box 50, and the insulating sheet 54 may also be omitted. Even without the heat-dissipating sheet 52, heat from the relay 110 is still transferred to the device base 42.

### Auxiliary Device Cover

The auxiliary devices 100 are arranged in multiple stages. Specifically, auxiliary devices 100 are also disposed above the device case 40, and these auxiliary devices 100 are covered with an auxiliary device cover 56. The auxiliary device cover 56 is provided above the device case 40 and supports the seat cushion SC of a rear vehicle seat from below. Another member may be interposed between the auxiliary device cover 56 and the seat cushion SC.

### Resin Member

A plate-like resin member 16 is disposed between the battery 10 and the upper case 12A. The resin member 16 extends in the vehicle front-rear direction and the vehicle width direction and covers the battery 10 from above.

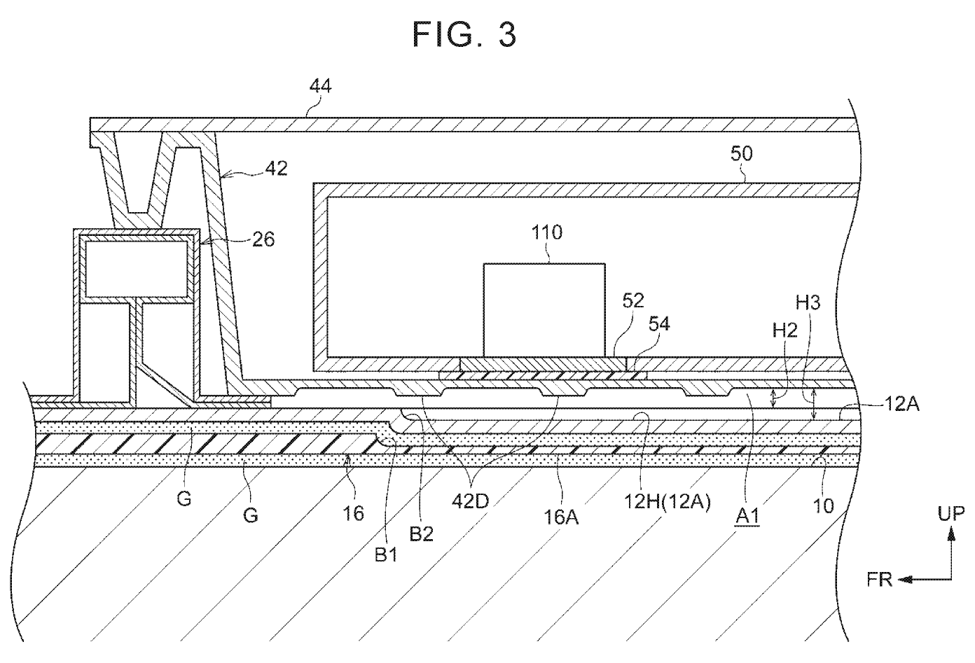

As shown in FIG. 3, the battery 10 and the resin member 16 are bonded together with an adhesive G. The upper case 12A and the resin member 16 are also bonded together with the adhesive G.

The resin member 16 includes a thin portion 16A below the junction box 50 and the relay 110. The upper surface of the thin portion 16A is positioned lower than the upper surfaces of the other portions of the resin member 16. The thin portion 16A and the adhesive G are not shown in FIG. 2.

As shown in FIG. 1, the upper case 12A has a plurality of recesses 12H extending downward. The shape of the recesses 12H is not particularly limited. For example, each recess 12H may be formed in a groove shape by a pair of walls extending downward from the upper surface of the upper case 12A and a bottom connecting the lower ends of the walls. The recesses 12H are each in the shape of a groove extending in the vehicle front-rear direction, and are arranged along the vehicle width direction.

As shown in FIG. 3, each recess 12H is formed above the thin portion 16A of the resin member 16. The recesses 12H are shaped to conform to the thin portion 16A.

The phrase "shaped to conform to the thin portion 16A" means that, when viewed from the side, a bent portion B1 of the resin member 16 and a bent portion B2 of the upper case 12A have the same or similar shape and are positioned close to each other. The bent portion B1 is the boundary between the thin portion 16A and the other portions of the resin member 16. The bent portion B2 is the boundary between the recesses 12H and the other portions of the upper case 12A.

In this configuration, the recesses 12H of the upper case 12A and the thin portion 16A of the resin member 16 are disposed below the relay 110.

The recesses 12H may not be shaped to conform to the thin portion 16A. The bent portion B1 of the resin member 16 and the bent portion B2 of the upper case 12A may have different shapes and may be spaced apart from each other.

The resin member 16 may not have the thin portion 16A. For example, the resin member 16 may instead be formed to have a uniform thickness in the vehicle front-rear direction. In the present disclosure, the resin member 16 may be omitted.

Regardless of whether the resin member 16 is provided, and regardless of whether the resin member 16, when provided, has the thin portion 16A, the upper case 12A may or may not have the recesses 12H.

### Thermally Insulating Structure

As shown in FIG. 2, an air layer A1 provides thermal insulation between the device base 42 and the upper case 12A below the relay 110 and the junction box 50.

The device base 42 has a fixing portion 42C that protrudes downward from the bottom surface of the device base 42. The fixing portion 42C is fixed to the upper case 12A. The thickness H2 of the air layer A1 is equal to the height by which the fixing portion 42C protrudes. The fixing portion 42C has an opening K1 that is located above the opening K2 of the upper case 12A.

As shown in FIG. 3, the air layer A1 communicates with the recesses 12H of the upper case 12A. Therefore, the air layer A1 that communicates with the recesses 12H has a greater thickness H3 in the regions where the recesses 12H are formed than the thickness H2 in the other regions.

The air layer A1 may be filled with various types of thermally insulating materials, such as fiber-based or foamed resin-based materials, in order to ensure thermal insulation performance.

### Heat-Dissipating Structure

As shown in FIG. 3, projections 42D that protrude downward toward the air layer A1 are formed on the lower surface of the device base 42. The portions where the projections 42D are formed are thicker than the other portions of the device base 42. Accordingly, the device base 42 has greater heat capacity compared with a configuration without the projections 42D.

The projections 42D increase the surface area of the lower surface of the device base 42 compared with a configuration without the projections 42D. As a result, heat is more readily dissipated from the device base 42 to the air layer A1.

The height by which the projections 42D protrude is smaller than the thickness H2 of the air layer A1 (i.e., the height by which the fixing portion 42C protrudes). This ensures that the projections 42D and the upper case 12A do not interface with each other.

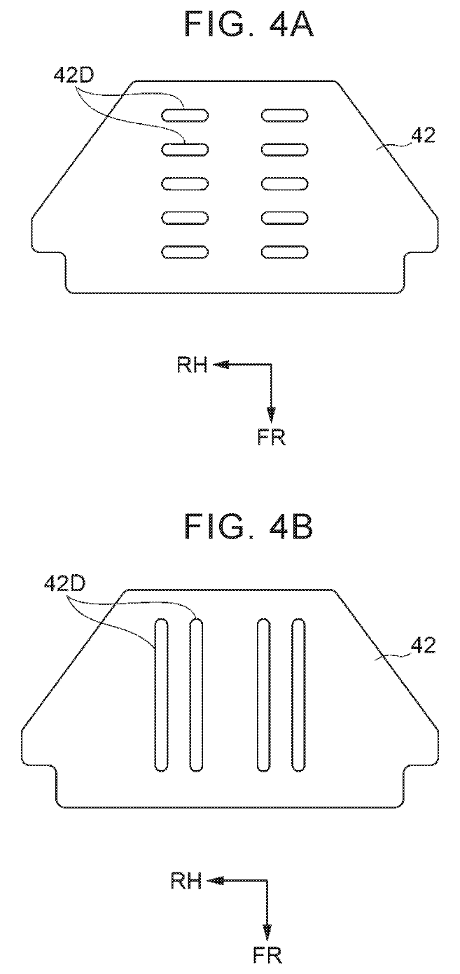

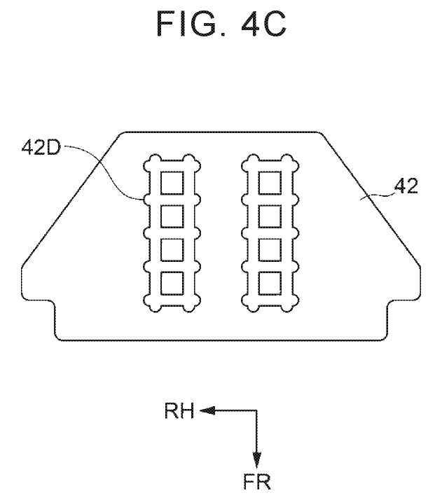

The shape of the projections 42D is not particularly limited. For example, as shown in FIG. 4A, each projection 42D may be formed as a rib extending in the vehicle width direction. Alternatively, as shown in FIG. 4B, each projection 42D may be formed as a rib extending in the vehicle front-rear direction. As shown in FIG. 4C, the projections 42D may be formed in a grid pattern extending in the vehicle width direction and the vehicle front-rear direction. Each projection 42D may be formed in a dot pattern, such as circular projections.

The size, length, height, positions, and number of the projections 42D may be selected as desired. For example, the projections 42D formed as ribs extending in the vehicle front-rear direction, as shown in FIG. 4B, can be positioned above the recesses 12H of the upper case 12A. In this case, since the projections 42D can protrude into the recesses 12H, the height of the projections 42D may be greater than the thickness H2 of the air layer A1.

### Functions and Effects

### Thermal Insulation and Heat Dissipation Effects

In the battery mounting structure according to the present embodiment, when the heat-generating devices such as the relay 110 shown in FIG. 2 are operated, the heat generated during operation is dissipated to the device base 42. The space between the device base 42 and the upper case 12A of the battery 10 is thermally insulated by air. Accordingly, transfer of heat from the device base 42 to the battery 10 through the upper case 12A is suppressed, thereby reducing partial heating of the battery 10.

Since the space between the device base 42 and the upper case 12A is thermally insulated, transfer of heat generated during operation of the battery 10 to the device base 42 through the upper case 12A is also suppressed. Accordingly, for example, when the heat-generating devices such as the relay 110 are not operating, localized cooling of the battery 10 is suppressed.

As described above, in the battery mounting structure according to the present embodiment, heat transfer between the heat-generating devices such as the relay 110 and the battery 10 is suppressed by the thermal insulation, thereby reducing the thermal influence of the devices on the battery 10.

The battery mounting structure according to the present embodiment includes the heat-dissipating sheet 52 serving as a thermally conductive member between the relay 110 and the device base 42. This facilitates heat dissipation from the relay 110 to the device base 42 and suppresses overheating of the relay 110, compared with a configuration without the heat-dissipating sheet 52.

In the battery mounting structure according to the present embodiment, the device base 42 is a casting. Compared with a case where the device base 42 is formed from a metal plate or resin, its thermal conductivity is higher, and heat is more readily dissipated from the heat-generating devices such as the relay 110 to the device base 42. As a result, overheating of the heat-generating devices such as the relay 110 can be suppressed.

In the battery mounting structure according to the present embodiment, the space between the device base 42 and the upper case 12A is thermally insulated by the air layer A1. Since air is a gas, it does not interfere with irregularities formed on the device base 42 or the upper case 12A (for example, the projections 42D formed on the device base 42; see FIG. 3). Therefore, compared with a configuration in which a thermally insulating material is laid between them, the shapes of the device base 42 and the upper case 12A are less restricted.

Since air has lower thermal conductivity than resin or metal, heat dissipated from the device base 42 is less likely to be transferred to the upper case 12A.

### Effects of Recesses

In the battery mounting structure according to the present embodiment, as shown in FIG. 3, the upper case 12A has the downward recesses 12H below the relay 110 and the junction box 50. The distance between the device base 42 and the upper case 12A is greater in the regions where the recesses 12H are formed (the thickness H3 of the air layer) than in the other regions (the thickness H2 of the air layer). Therefore, the thermal insulation effect is enhanced compared with a configuration without the recesses 12H.

### Effects of Resin Member

In the battery mounting structure according to the present embodiment, the plate-like resin member 16 is disposed between the battery 10 and the upper case 12A. A load acting locally on the upper case 12A that forms the floor of the vehicle cabin is therefore distributed by the resin member 16. Accordingly, localized loads are less likely to act on the battery 10.

The resin member 16 includes, below the relay 110 and the junction box 50, the thin portion 16A whose upper surface is positioned lower than the upper surfaces of the other portions of the resin member 16. The upper case 12A has the recesses 12H above the thin portion 16A. In other words, the thin portion 16A of the resin member 16 forms a space that allows the recesses 12H to be formed in the upper case 12A.

Since the recesses 12H are formed above the thin portion 16A, the depth of the recesses 12H can be increased compared with a case where the recesses 12H are formed in other regions. As a result, the resin member 16 suppresses localized loads acting on the battery 10, and at the same time, the recesses 12H of the upper case 12A enhance the thermal insulation effect.

### Effects of Projections

In the battery mounting structure according to the present embodiment, the projections 42D that protrude downward toward the air layer A1 are formed on the lower surface of the device base 42. Since the projections 42D increase the surface area of the lower surface of the device base 42, heat is more readily dissipated from the device base 42 to the air layer A1. Therefore, compared with a configuration without the projections 42D, heat generated by the heat-generating devices such as the relay 110 is more readily dissipated to the device base 42.

On the other hand, since air has lower thermal conductivity than resin or metal, heat dissipated from the device base 42 is less likely to be transferred to the upper case 12A through the air layer A1 between the device base 42 and the upper case 12A. Therefore, heat transfer to the battery 10 can be suppressed.

As described above, the shape of the projections 42D is not particularly limited. When the projections 42D are formed in a grid pattern, the surface area of the lower surface of the device base 42 can be more easily increased compared with a case where the projections 42D are formed as linear ribs or in a dot pattern.

Alternatively, when the projections 42D are formed as ribs extending in the vehicle front-rear direction, the projections 42D can be positioned above the recesses 12H. In this case, the projections 42D can protrude into the recesses 12H. As a result, heat is more readily dissipated from the device base 42 to the air in the air layer A1 and the recesses 12H.

What is claimed is:

1. A battery mounting structure for a vehicle, the battery mounting structure comprising:
an upper cover disposed above an energy storage cell;
a device disposed above the energy storage cell and the upper cover and electrically connected to the energy storage cell;
a device base on which the device is mounted, the device base being made of metal and disposed above the upper cover with a gap between the device base and the upper cover; and
a projection provided on a lower surface of the device base and protruding downward.

2. The battery mounting structure according to claim 1, wherein:
the device base is box-shaped and has an opening at an upper end of the device base; and
the battery mounting structure further includes a lid that closes the opening at the upper end of the device base.

3. The battery mounting structure according to claim 1, wherein the projection is provided in a grid pattern along a vehicle width direction and a vehicle front-rear direction.

4. The battery mounting structure according to claim 1, wherein the device is partially disposed above the energy storage cell and the upper cover.
